(19) United States
(12) Patent Application Publication
(10) Pub. No.: US 2007/0046009 A1
(43) Pub. Date: Mar. 1, 2007

(54) Head protecting air bag

(75) Inventors: Wataru Miura, Aichi-ken (JP); Taizo Suemitsu, Aichi-ken (JP); Yasuo Ochiai, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/500,300

(22) Filed: Aug. 8, 2006

(30) Foreign Application Priority Data
Aug. 30, 2005 (JP) 2005-248818

(51) Int. Cl. B60R 21/23

(52) U.S. Cl. 280/743.2; 280/730.2

(57) ABSTRACT

The air bag is provided with a non-inflatable part, an inflatable part and a coupling part. The coupling part is made by providing a slit portion in a part of the non-inflatable part, and the coupling part and non-inflatable part are joined together continuously at a connecting end portion so as to form an integral structure. The slit portion is provided in a position immediately before a terminal end on the side of the connecting end portion with a curved section for scattering a load imparted to the connecting end portion. The slit portion is further provided at the terminal end on the side of the connecting end portion of the coupling part with a substantially circular hole-like section for scattering a load imparted to the connecting end portion.

### BACKGROUND OF THE INVENTION

1. Field of the Invention

The present invention relates to an air bag, especially to a head protecting air bag mounted on an automobile. More particularly, the invention relates to a structure of a belt-like coupling part extending from a longitudinal end portion of the air bag and joined to a vehicle.

2. Related Art

The related art head protecting air bags of this kind include a structure which uses a member formed separately from a head protecting air bag and utilized as a member of a coupling part for joining the end portion in the longitudinal direction of the vehicle of the air bag to a portion of the vehicle, and which is fixed to the air bag, this structure being disclosed in a patent publication (refer to, for example, JP-A-2004-182026). A head protecting air bag of a structure having a member formed separately from the air bag and similar to a belt is also disclosed in a patent publication (refer to, for example, JP-A-2001-071856). A head protecting air bag of a structure in which a non-inflatable part of the air bag is extended as a member of a coupling part is also disclosed in a patent publication (refer to, for example, JP-A-2001-270413).

However, in order to form the coupling part utilizing a member made separable from the air bag, it is necessary that the connecting member be secured firmly to the air bag, so that the connecting member attachment (fixing) step has to be carried out in the air bag manufacturing stage.

In order to employ a method of forming the member of the coupling part by extending a non-inflatable part of the air bag, the non-inflatable part is necessarily extended by a distance (length) corresponding to a distance between the end portion of an inflatable part of the air bag and the attachment portion of the vehicle. Therefore, a ground cloth (a woven material) is used excessively in a corresponding quantity.

Therefore, the structure for the coupling part has room for improvement, i.e. a higher yield thereof, and an inexpensive method of manufacturing the same have to be attained.

### SUMMARY OF THE INVENTION

The present invention aims at solving these problems, and providing an air bag, suitable for a head protection head, having a simple structure and capable of being manufactured inexpensively.

One aspect of the air bag according to the present invention has an air bag comprising: an inflatable part; a non-inflatable part; and a coupling part defined in an end portion of the air bag for coupling to a vehicle; wherein a slit portion is formed in the air bag such that that the coupling part is separatable from the non-inflatable part while being connected at a connecting end portion of the coupling part.

In this invention, it is preferable that, in the slit portion, the connecting end portion of the coupling part be provided with a curved section.

In this invention, it is preferable that the curved section be arcuate and has a predetermined radius.

Furthermore, it is preferable in these inventions that the coupling part be formed to a substantially a belt-like shape, and that the narrow portion of the coupling part in which a width thereof becomes the smallest be provided in the section thereof which is other than the connecting end portion thereof.

In these inventions, it is preferable that a terminal part of the connecting end portion of the coupling part be provided with a substantially circular hole-like section.

In the air bag according to the present invention, a slit portion is provided in a part of the non-inflatable part so that a section of the coupling part except the connecting end portion thereof becomes able to be separated from the non-inflatable part with the connecting end portion of the coupling part and the non-inflatable part in a joined state, the non-inflatable part thus forming the coupling part. Therefore, the non-inflatable part of the air bag and coupling part are put in a continuous united state in advance, so that the step of attaching the air bag to the coupling part is omitted. Since the coupling part is used separately from the non-inflatable part, the non-inflatable part may not be extended to even a distance (length) corresponding to that between the end section of the inflatable part of the air bag and the attachment portion of the vehicle, and the quantity of use of the ground cloth (woven material) serving as a material for the coupling part for the air bag can be minimized. This enables the air bag to be formed to a simple structure and manufactured inexpensively.

When a curved section is provided on the slit portion of the connecting end portion of the coupling part, the concentration (i.e. stress concentration) of a load imparted to the terminal end portion of the slit portion is scattered on the curved section of the coupling part. Therefore, the breakage starting from this portion of the coupling part can be inhibited. Since forming a part of the slit portion only to a curved shape can meet the purpose, the coupling part, which is capable of inhibiting the breakage of the air bag when the air bag is expanded, of the air bag can be formed to a simple structure and manufactured inexpensively.

When the curved section is formed to a predetermined radius, the above-mentioned concentration of a load is substantially uniformly scattered on the curved section. Accordingly, the breakage starting from this portion of the air bag can be inhibited more stably. Since the curved section may only be formed to an arcuate shape having a predetermined radius, the coupling part, which is capable of inhibiting the breakage thereof when the air bag is expanded, can be formed to a simple structure and manufactured inexpensively.

When the coupling part is formed to a belt-like shape, and, when the portion thereof which becomes smallest in width is provided on the portion of the same which is other than the connecting end portion of the coupling part, this thinnest portion becomes a portion on which a load is readily concentrated when the air bag is expanded. Therefore, this thinnest portion is set to a dimension (width) which permits the narrow portion to sufficiently withstand a load occurring due to the expansion of the air bag, the coupling part as a whole necessarily becomes able to sufficiently withstand the load occurring due to the expansion of the air bag. The connecting end portion in which the coupling part and non-inflatable part continue naturally has a size larger than that of this narrow portion. Therefore, the strength of the coupling part during the expansion of the air bag is necessarily secured. Since the narrow portion having a sufficient strength may only be provided on a general portion of the belt-like coupling part, the coupling part in which the strength necessary when the expansion of the air bag takes place is secured can be manufactured to a simple structure.

When a substantially circular hole-like section is provided in the terminal part of the connecting end portion of the coupling part in the slit portion, the concentration (i.e. stress concentration) of a load imparted to the terminal end portion of the slit portion when the air bag is expanded is scattered substantially uniformly on a region around the hole-like section. Therefore, the breakage of the air bag starting from this section can be inhibited. Since the providing of a substantially circular hole-like section only in the terminal end portion of the slit portion, the coupling part of the air bag which can inhibit the breakage of the air bag occurring during the expansion thereof can be formed to a simple structure, and manufactured inexpensively.

### BRIEF DESCRIPTION OF THE DRAWINGS

FIG. 1 is a front view showing the developing condition of the head protecting air bag of one embodiment according to the present invention during the expansion thereof.

FIG. 2 is a partial enlarged view showing a part of a front side portion of a vehicle of FIG. 1.

FIG. 3 is a front view showing the non-expanded developed condition in the manufacturing stage of the head protecting air bag of the embodiment shown in FIG. 1.

FIG. 4 is a front view showing the non-expanded developed condition in the manufacturing stage of a modified example of the embodiment.

### DETAILED DESCRIPTION OF THE PREFERRED EMBODIMENTS

The embodiments of the present invention will now be described on the basis of the drawings.

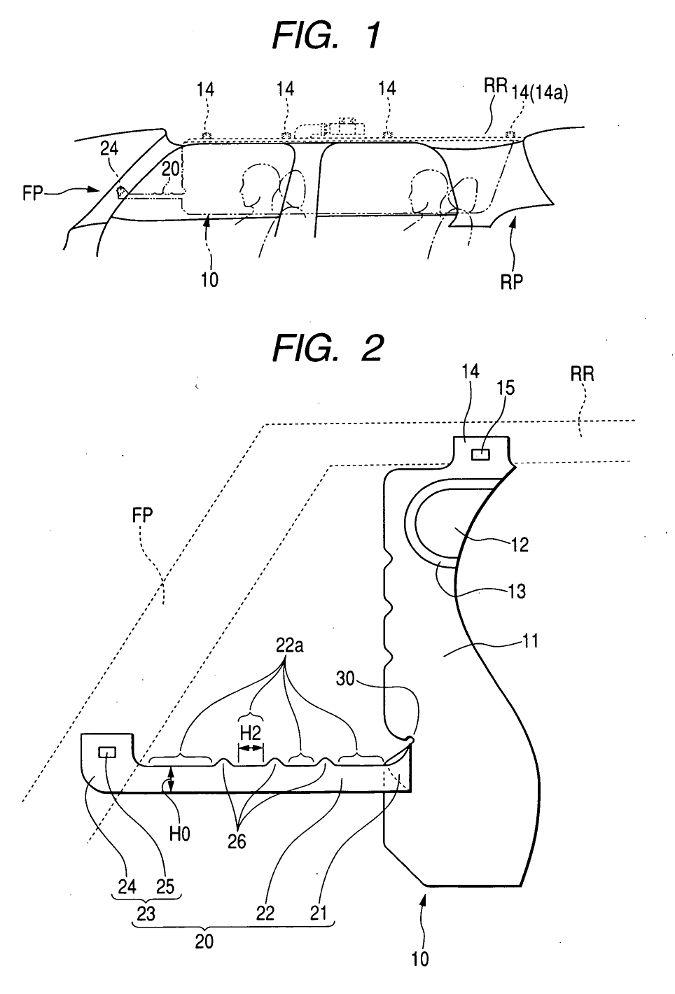

A head protecting air bag 10 (which will hereinafter be referred to the air bag 10) in an embodiment is used for a head protecting air bag apparatus mounted on a vehicle as shown in FIG. 1 and FIG. 2. The air bag 10 is retained in a folded state and wound with a wrapping material (not shown). The air bag 10 in this condition is arranged over a front pillar FP extending around upper edges of a door and a window on the side of the interior of a vehicle, roof side rails RR, and an upper portion of a rear pillar RP (the condition of storage of the air bag 10 is not shown). FIG. 1 and FIG. 2 show the condition of the air bag 10 expanded by an operation of a head protecting air bag apparatus with the expansion of the air bag 10 completed. When the air bag 10 is thus expanded, tension is imparted to a part between an attachment portion 24 for a coupling part 20 which will be described later of the air bag 10 and an attachment portion 14a positioned in the rearmost portion of the vehicle out of the attachment portions 14 on an upper end side of the air bag 10 which will also be described later. This tension occurs since an inflatable part 12 of the air bag 10 which will be described later is expanded to cause the height of the air bag 10 to increase and the length thereof in the longitudinal direction of the vehicle to decrease.

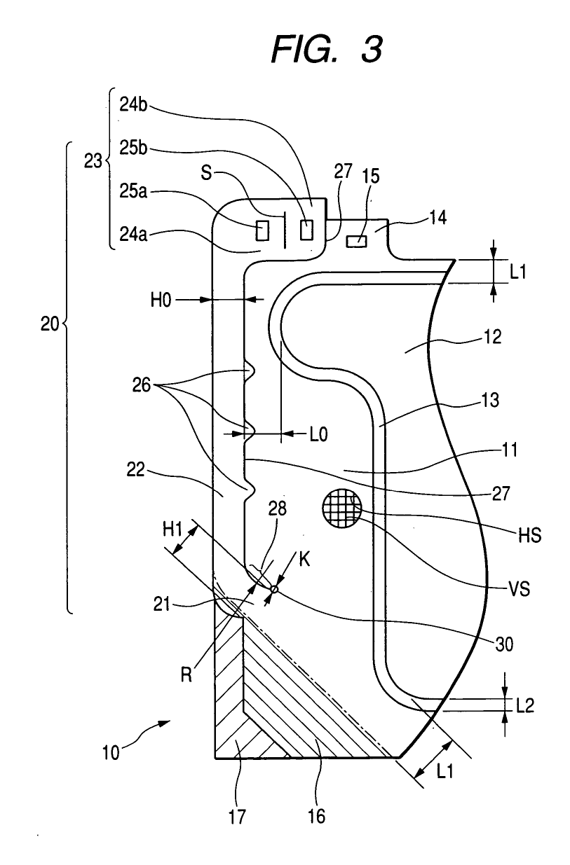

As shown in FIG. 2 and FIG. 3, the air bag 10 of an embodiment has a non-inflatable part 11 and an inflatable part 12. In this embodiment, the air bag 10 is made of a hollow-woven ground fabric, in which the non-inflatable part 11 and inflatable part 12 are formed in one body, and the non-inflatable part 11 is provided with a boundary part 13 in a predetermined range of region away from a circumference of the inflatable part 12. This boundary part 13 is provided along the outer circumference of the inflatable part 12, and has a predetermined dimension (width) L2. Although this dimension L2 is set to 10 mm in this embodiment, an arbitrary size may be employed as long as a satisfactory strength can be obtained. In this embodiment, the construction of the hollow-woven fabric of the boundary part 13 is different from that of the hollow-woven fabric of the non-inflatable part 11 exclusive of the inflatable part 12 and boundary part 13.

The air bag 10 of the embodiment has attachment portions 14 (in FIG. 2 and FIG. 3, one attachment portion only that is provided in one position on the foremost portion of the vehicle is shown) which are used to fix the air bag 10 to the roof side rails RR of the vehicle as shown in FIG. 1 to FIG. 3. These attachment portions 14 have attachment holes 15 used to pass therethrough attaching bolts, clips and the like for the vehicle, the attachment holes 15 being provided in plural in the longitudinal direction of the vehicle. In the embodiment, the air bag 10 is fixed to the roof side rails RR of the vehicle by using bolts (not shown) via the attachment portions 14. In FIGS. 1 and 2, only the portion of the air bag 10 that corresponds to the front side of the vehicle is illustrated, and an illustration of the portion of the air bag 10 corresponding to the rear side of the vehicle is omitted. The front and rear, left and right, and upper and lower sides referred to in the specification shall be based on the front side in the direction of advance of the vehicle viewed from the crew's (driver's) angle unless specifically noted. In this connection, the air bag 10 in FIG. 1 and FIG. 2 shows the condition of a head protecting air bag apparatus expanded and developed in a window side portion of the interior of the vehicle and viewed from the interior of the vehicle. FIG. 3 shows an air bag 10 being manufactured, though the condition of the direction in which this air bag 10 extends when the air bag 10 is mounted on a vehicle is impossible, a description of which will be given by assuming that the direction in which the air bag 10 is mounted on a vehicle agrees with that shown in FIG. 1 and FIG. 2, so as to make this description of the direction easily understandable. The invention shown in this specification can be applied not only to a head protecting air bag apparatus expanded and developed on the right window side of the interior of a vehicle but also to a head protecting air bag apparatus expanded and developed on the left window side of the interior of a vehicle.

As shown in FIG. 2 and FIG. 3, the coupling part 20 is formed by providing the slit portion 27 of the non-inflatable part 11 at the front end portion, which is on the front side of the vehicle, of the air bag 10. The coupling part 20 includes three portions, i.e. the connecting end portion 21 joined continuously to the air bag in one body, a separable end portion 23 made separable with respect to the air bag 10, and a substantially belt-like general portion 22 made separable with respect to the air bag 10 in the same manner as the separable end portion 23 and constituting a portion between the connecting end portion 21 and separable end portion 23. The slit portion 27 is provided so that the separable end portion 23 and general portion 22 (i.e. portions excluding the connecting end portion 21) of the coupling part 20 are separable from the air bag 10. A distance L0 between the slit portion 27 and inflatable part (i.e. the portion occupied by the non-inflatable part 11 including the boundary part 13 is set at the shortest section thereof to 20 mm. This distance L0 is provided for the purpose of preventing a fray of the boundary part 13 from occurring. In order to obtain a stable strength of the boundary part 13 so as to prevent the same portion from being frayed, it is preferable that the distance L0 be set not shorter than 20 mm. Also, a distance L1 between the inflatable part 12 and an outer peripheral portion forming an outer shape of the air bag 10 is preferably set at the shortest section thereof be set to not shorter than 20 mm. In the embodiment, both the distance L0 and distance L1 are set to 30 mm.

In this embodiment, the coupling part 20 is formed as a substantially belt-like member extending in the substantially vertical direction by utilizing the non-inflatable part 11 in a front end section with respect to the vehicle of the air bag 10. The embodiment is not limited to this, i.e., the coupling part 20 may also be formed as a substantially belt-like member extending in the substantially longitudinal direction by utilizing the non-inflatable part 11 in a lower end section with respect to the vehicle of the air bag 10. In addition, the coupling part 20 may also be formed as a substantially belt-like member by utilizing a combination of these non-inflatable parts 11. Namely, the coupling part 20 may also be formed as an L-shaped substantially belt-like member, a diagonally arranged substantially belt-like member, and a substantially belt-like member in which adjacent U-shaped members are arranged continuously in an alternately changed manner at the upper and lower portions thereof so as to gain the length (like a sine wave). As a further applied example, the coupling part may be formed as a structure in which the coupling part is joined to a part above (for example, a position of an attachment portion 14a) the rear pillar RP by utilizing the non-inflatable part 11 at the rear end section of the vehicle.

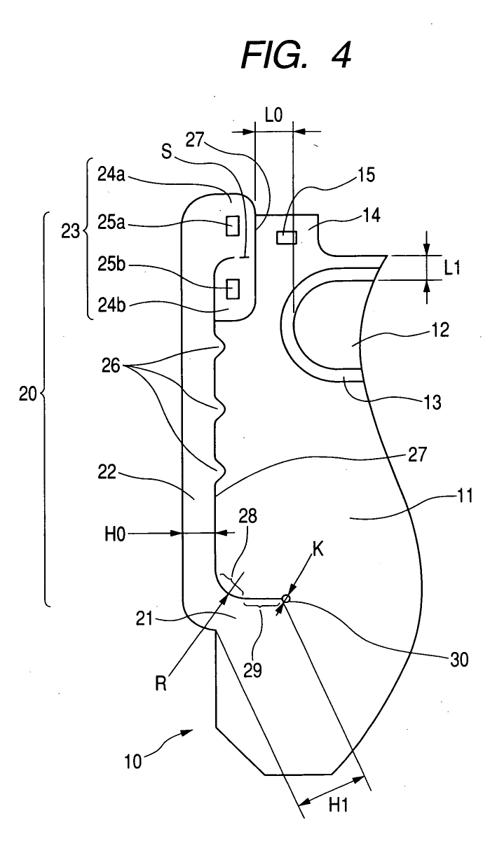

The separating end portion 23 of the coupling part 20 is provided with the attachment portion 24 therefor used to secure the coupling part 20 to the front pillar FP of the vehicle. The attachment portion 24 of the coupling part 20 is provided with attachment holes 25 therein, through which bolts or clips etc. for securing the coupling part 20 to the vehicle are inserted, in the same manner as the attachment portion 14 for securing the air bag 10 to the roof side rail RR. In the embodiment, the air bag 10 is fixed to the front pillar FP of the vehicle by using bolts (not shown) via the attachment portion 24. In the attachment portion 24 of the coupling part 20 in this embodiment, a base portion 24a and a flap portion 24b are arranged side by side in the longitudinal direction when the air bag 10 is cut out from a base cloth. After the air bag 10 is cut out from the base cloth, the air bag 10 is folded along a fold line S, and the flap portion 24b is thereby folded toward the base portion 24a, the base portion 24a and flap portion 24b being laminated on each other. The direction in which the folding portion 24b is bent may be either the direction extending this side of the outer surface of FIG. 3 or the direction extending the rear side of the same figure. In order to laminate the base portion 24a and flap portion 24b on each other, the attachment hole of the base portion 24a and that 25b of the flap portion 24b are aligned with each other, the attachment hole 25 of the coupling part 20 being thus formed. The attachment holes 25a, 25b may be made as the attachment hole 25 after the base portion 24a and flap portion 24b are laminated on each other without making the attachment holes 25a, 25b when the air bag 10 is cut out from the base cloth. The methods of combining the base portion 24a and flap portion 24b with each other may include a bonding method, a sewing method and the like but the means used in the methods are not specifically limited. Furthermore, a structure not provided with the flap portion 24b may be employed as long as the strength of the base portion 24a is satisfactorily high. Also, a structure provided with not smaller than two flap portions 24b may be employed. When the air bag 10 is cut out from a base cloth, the base portion 24a and flap portion 24b may be arranged on the attachment part 24 in the vertical direction as in another example shown in FIG. 4. The base cloth of the air bag 10 is a hollow woven fabric obtained by arranging weft HS and warp VS substantially at right angles to each other. In this embodiment, the weft HS is arranged in the longitudinal direction of the vehicle of the air bag, and the warp VS in the vertical direction of the vehicle of the air bag 10.

The general portion 22 of the coupling part 20 is formed as a substantially a belt-like member extending substantially in the vertical direction with respect to the air bag 10 along fine lines (warp VS). This general portion 22 is provided with convex sections 26 as discrimination signs for improving the operation efficiency (preventing the occurrence of erroneous assembling) during the mounting of the head protecting air bag apparatus on a vehicle. The general portion 22 has a constant dimension (width) H0 except these convex sections 26. In this embodiment, the portions having this dimension H0 form narrowest sections 22a of the general portion 22. The coupling part 20 also functions as a so-called tension belt as well so that the air bag 10 is expanded and developed with a suitable tension. Therefore, it is necessary that the coupling part 20 be resistant a certain degree of tension. During this time, the general portion 22, which forms the belt-like portion, resists owing to this tension as in this embodiment even a load concentrated thereon. When the narrow portion 22a of the dimension H0 is provided, the coupling part 20 necessarily has a strength high enough to resist sufficiently even when the air bag 10 is developed and expanded. Moreover, the tension is imparted to the general portion 22, which is a part of the belt-like portion, in the longitudinal direction thereof, so that, when the narrow portion 22a has a certain degree of the dimension H2 in the longitudinal direction of the general portion 22 as in the embodiment, the portion of the dimension H2 necessarily receives the concentrated load in a substantially uniformly. Therefore, the coupling part becomes a structure in which a load is difficult to be concentrated on one point, so that the structure is desirable. In the embodiment, the dimension H2 of the shortest portion is 30 mm, and that H0 of the portions (the narrow portions 22a) 175 mm in total. There may be a plurality of narrow portions 22a as in this embodiment, or may be restricted to one position as long as the narrow portion 22 has a satisfactory strength even when consideration is not given to the concentration of a load to one point. However, when the dimension H0 is varied in the portion adjacent to the narrow portion 22a, it is preferable that the dimension H0 be changed gently and gradually so that the concentration of a load in the point of change is inhibited.

The coupling part 20 is obtained by providing a slit portion 27 in the non-inflatable part 11 of the air bag 10, and the connecting end portion 21 of the coupling part 20 is joined in one body continuously to the non-inflatable part 11 on the front side of the vehicle of the air bag 20. The slit portion 27 starts being bent from the end section of the connecting end portion 21 of the general portion 22 toward an anti-outer shape side (inflatable part 12) of the air bag 10, and a curved section 28 is formed on the connecting end portion 21 (more in detail, the section immediately before the terminal end region of the slit portion 27 on the side of the connecting end portion 21 of the coupling part 20 of the slit portion 27). In the embodiment, this curved section 28 is formed as an arc obtained by dividing a circle of a radius of 25 mm into substantially four parts. It is preferable that the radius R of this curved section 28 and the dimension H0 of the narrow portion 22a be set to the dimension H0≦the radius R taking into consideration the scattering of the concentrated load imparted to this curved section 28 during the expansion and development of the air bag 10. In this case, the dimension H1 of the connecting end portion 21 of the coupling part 20 and the dimension H0 of the narrow portion 22a may be determined as long as the relational expression of the dimension H0≦the dimension H1 is effected. In this embodiment, the slit portion 27 is formed as a slit which is formed by simply cutting the non-inflatable part, and which has no width (width: 0 mm). The slit portion 27 may also be formed as a notch having a width like a gap. When the slit portion 27 is formed as a notch, the distance between the outer peripheral part formed by the notch and constituting the outer peripheral shape of the air bag 10 and the inflatable part 12 is set in proportion to the distance L1.

As shown in FIG. 3, a substantially circular hole-like section 30 of 6 mm in diameter K is provided which has the center at the terminal end portion on the side of the connecting end portion 21 of the coupling part 20 of the slit portion 27. In the case of this embodiment, the weft HS forming the base cloth of the air bag 10 is arranged in the longitudinal direction of the vehicle with the warp VS in the vertical direction thereof. Accordingly, a load tearing (i.e., cutting the base cloth by pulling the warp VS) the base cloth of the air bag 10 is necessarily imparted to the terminal end on the side of the connecting end portion 21 in the coupling part 20 of the slit portion 27 in the embodiment when the air bag 10 is expanded and developed. However, owing to the existence of this hole-like section 30, the concentration of the load is necessarily inhibited with respect to the circumference of the terminal end portion on the side of the connecting end portion 21 of the slit portion 27 in the coupling part 20. It is preferable that the diameter K of this hole-like section 30 be set-not smaller than 2 mm with the effective scattering of the concentrated load into consideration. However, it is preferable that, in view of the necessity of setting the dimension H1 larger than that H0, the diameter K of the hole-like section 30 be suppressed to not larger than 10 mm. In the case where the curved section 28 is provided in the terminal end of the slit portion 27, a linear extension section 29 continuing smoothly to the curved section 28 is provided as shown in FIG. 4, and the hole-like section 30 may be provided in the end portion thereof. In the embodiment, the extension section 29 extends longitudinally along the fine line (weft HS) with respect to the air bag 10.

In the embodiment, the outer shape of the connecting end portion 21 is as shown by a solid line in FIG. 3. When the connecting end portion 21 has this shape, connecting end portion may be extended to an arbitrary shape within a hatched region, i.e. an extensible region 17 enclosed with a solid line and a broken line (a dotted line) in FIG. 3 when the yield of the air bag 10 cut out from the base cloth therefor is not adversely affected. Namely, the connecting end portion 21 may be extended to an arbitrary shape within the range of the extensible region 17. This means that, when the connecting end portion 21 can obtain a strength equal to that of the mentioned narrow portion 22a, the shortest distance between the terminal end on the side of the connecting end portion 21 on the coupling part 20 of the slit portion 27 and the outer edge of the air bag 10 (or coupling part 20), i.e. the dimension H1 of the connecting end portion 21 of the coupling part 20 may be not smaller than the dimension H0, and that the width of the coupling part 20 in the curved section 28 may also be not smaller than the dimension H0. In short, the connecting end portion 21 may be removed to form the same to an arbitrary shape within the hatched region enclosed with the solid line and one-dot chain line in FIG. 3, i.e., within the range of the removable portion 16. In other words, the connecting end portion 21 may be formed to an arbitrary outer shape in a region as long as the region is within the range of both the extensible portion 17 and removable portion 16. Namely, the purpose is met when the relational expression of the dimension H0≦the dimension H1 is effected.

In the condition in which the air bag 10 is mounted on a vehicle and developed and expanded as shown in FIGS. 1 and 2, and, when the air bag 10 is being folded so as to be mounted on a vehicle, the coupling part 20 is turned counter-clockwise at 90° with respect to the air bag 10 around the circumference of the connecting end portion 21. It is preferable that the portion, in which the connecting end portion 21 is provided, of the coupling part 20 be in a position lower than the vertical center of the non-inflatable part 11. In the embodiment, the connecting end portion 21 is provided in a position substantially ⅓ from the lower end of the air bag 10 toward the upper end thereof with respect to the vertical size of the non-inflatable part 11.

The air bag 10 may be made of two laminated cloths as other modified example. The two cloths in this example may be combined with each other by bonding or sewing using bonding means not specifically limited. In this case, the coupling part 20 may be provided with a non-inflatable part 11 in which two cloths are laminated on each other, a one-piece cloth structure of either one of such cloths. The air bag 10 may be made of either non-coated cloths or coated cloths. Furthermore, the cut surfaces (end portions) of the outer surface, slit portion 27 and hole-like section 30 may be subjected to a fraying preventing treatment (for example, heating these portions and melting and solidifying the cut surfaces of the base cloths (fiber) of the air bag and the like).

What is claimed is:

1. An air bag comprising:
an inflatable part;
a non-inflatable part; and
a coupling part defined in an end portion of the air bag for coupling to a vehicle;
wherein a slit portion is formed in the air bag such that that the coupling part is separatable from the non-inflatable part while being connected at a connecting end portion of the coupling part.

2. An air bag according to claim 1, wherein a curved section in the slit portion is provided at the connecting end portion.

3. An air bag according to claim 2, wherein the curved section has an arcuate shape of a predetermined radius.

4. An air bag according to claim 1, wherein the coupling part has a substantially belt-like shape, and
a narrow portion which has a width smaller than other portions of the coupling part is formed in a portion of the coupling part other than the connecting end portion.

5. An air bag according to claim 1, wherein a terminal end of the connecting end portion of the coupling part is provided with a circular hole-like section.

6. An air bag according to claim 1, wherein the slit portion includes a slit having no width.

7. An air bag according to claim 1, wherein the slit portion is formed in the non-inflatable portion.

8. A head protection air bag apparatus comprising an air bag according to claim 1 mounted on a vehicle.
